(19) United States
(12) Patent Application Publication
(10) Pub. No.: US 2007/0279509 A1
(43) Pub. Date: Dec. 6, 2007

(54) Arrangement for and method of projecting an image with modulated lasers

(76) Inventors: Chinh Tan, Setauket, NY (US); Miklos Stern, Woodmere, NY (US); Dmitriy Yavid, Stony Brook, NY (US); Askold Strat, Sound Beach, NY (US); Frederick F. Wood, Medford, NY (US); Michael Slutsky, Stony Brook, NY (US); Richard Rizza, N Bellmore, NY (US); Carl Wittenberg, Water Mill, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/446,752

(22) Filed: Jun. 5, 2006

(51) Int. Cl. H04N 5/222

(52) U.S. Cl. 348/333.1

(57) ABSTRACT

An acousto-optical modulator modulates a green laser beam, and generates a modulated non-diffracted beam and a modulated diffracted beam. A scanner sweeps the modulated diffracted green beam, as well as modulated red and blue beams, as a pattern of scan lines, each scan line having a number of pixels. A controller causes selected pixels along the scan lines to be illuminated, and rendered visible, by the diffracted green beam, the red beam and the blue beam to produce the image. The non-diffracted green beam is employed in a laser shut-down safety circuit.

### BACKGROUND OF THE INVENTION

1. Field of the Invention

The present invention generally relates to projecting a two-dimensional image of high quality especially in color using modulated lasers.

2. Description of the Related Art

It is generally known to project a two-dimensional image on a projection surface based on a pair of scan mirrors which oscillate in mutually orthogonal directions to scan a laser beam over a raster pattern comprised of a plurality of scan lines. The image is created in the raster pattern by modulating or pulsing a laser on and off at selected times, thereby illuminating selected pixels and not illuminating other pixels in each scan line. Color images can be obtained by modulating red, blue and green lasers and illuminating the selected pixels by superimposing one or more of the red, blue and green laser beams emitted by the respective lasers on a respective pixel to obtain a desired color.

In order to produce an image of high resolution, i.e., VGA or higher, modulation frequencies greater than 50 MHz, and typically on the order of 100 MHz, are needed. Semiconductor lasers can be modulated directly via their applied drive currents at such high frequencies, and red and blue semiconductor lasers capable of being modulated at such high frequencies are currently commercially available, but green semiconductor lasers are not. Hence, to produce a green laser beam, it is known to frequency double a diode-pumped, solid-state (DPSS) laser. Sometimes, a DPSS laser is used to generate a red or a blue beam when a high laser output power is needed. Unfortunately, DPSS lasers have a slow response time and, as a result, the beam generated by a DPSS laser needs to be modulated by a modulator, typically a modulator external to the DPSS laser.

In addition, the output power of each laser must be monitored for safety. Although the image brightness is enhanced when the output power of each laser is increased, government regulatory safety standards dictate the maximum power output of each laser for human safety. Some of these standards require that the output power of each laser does not exceed regulatory limits even when control circuitry that normally regulates the laser output power fails.

For example, a monitor photodiode inside the laser housing is normally operative for monitoring the laser output power. The monitor photodiode is part of a feedback circuit for maintaining the laser output power constant during operation. If the monitor photodiode were to fail, or to become electrically disconnected from the feedback circuit, then the feedback signal would be lost, and the feedback circuit would increase the laser output power, possibly to a level exceeding regulatory limits and compromise user and bystander safety.

### SUMMARY OF THE INVENTION

### OBJECTS OF THE INVENTION

Accordingly, it is a general object of this invention to provide an image projection arrangement that projects a two-dimensional image, especially in color, of high resolution in accordance with the method of this invention.

Another object of this invention is to modulate each laser in such projection arrangements at high modulation frequencies.

Yet another object of this invention is to control the output power of each laser to meet safety standards.

An additional object is to provide a miniature, compact, lightweight, and portable color image projection module useful in many instruments of different form factors.

### FEATURES OF THE INVENTION

In keeping with these objects and others, which will become apparent hereinafter, one feature of this invention resides, briefly stated, in an image projection arrangement for, and a method of, projecting a two-dimensional image of high resolution, especially in color. The arrangement includes a laser assembly for generating a laser beam; a scanner for sweeping the laser beam as a pattern of scan lines on a projection surface at a distance from the laser assembly, each scan line having a number of pixels; and a controller operatively connected to the laser assembly and the scanner, for causing selected pixels to be illuminated, and rendered visible, by the laser beam to produce the image.

In accordance with one aspect of this invention, the laser beam is modulated by an acousto-optical modulator (AOM) operative for modulating the laser beam, and for generating a modulated non-diffracted beam and a modulated diffracted beam. In the preferred embodiment, the laser assembly includes a plurality of lasers for respectively generating a plurality of laser beams of different wavelengths, for example, red, blue and green laser beams. As previously discussed, the red and blue lasers can be directly modulated at high modulation frequencies, but the currently commercially available green lasers cannot. As a result, the AOM is advantageously used to modulate the green beam to produce a modulated non-diffracted green beam and a modulated diffracted green beam.

Advantageously, the green beam is focused by a focusing lens to a waist having a size on the order of 100 micrometers or less and is positioned generally in the center of the AOM. A radio frequency (RF) signal of variable amplitude and derived from the incoming video signal is applied to a piezoelectric transducer operative to propagate an acoustic traveling wave inside a crystal in the AOM. The AOM is optimally aligned with the incident green beam at a positive Bragg angle and generates the modulated non-diffracted green beam as a zero-order beam and the modulated diffracted green beam as a positive first-order beam. The angle between the zero-order beam and the positive first-order beam is twice the Bragg angle. The AOM could also be aligned at a negative Bragg angle, in which case, the modulated diffracted green beam is a negative first-order beam

The non-diffracted green beam is collinear with the incident green beam and, hence, would be easier to align with the scanner. However, this invention instead employs the modulated diffracted green beam because the modulated diffracted green beam can be completely turned off, thereby enhancing the contrast and the extinction ratio between the illuminated and the non-illuminated pixels. The modulated non-diffracted green beam cannot be completely turned off.

The arrangement further advantageously includes an optical assembly for focusing and nearly collinearly arranging the red beam, the blue beam and the diffracted green beam to form a composite beam which is directed to the scanner. The scanner preferably includes a first oscillatable scan mirror operative for sweeping the composite beam along a first direction at a first scan rate and over a first scan angle, and a second oscillatable scan mirror operative for sweeping the composite beam along a second direction substantially perpendicular to the first direction, and at a second scan rate different from the first scan rate, and at a second scan angle different from the first scan angle. At least one of the scan mirrors is oscillated by an inertial drive.

The controller includes means for energizing the laser assembly to illuminate the selected pixels, and for deenergizing the laser assembly to non-illuminate pixels other than the selected pixels. Since the AOM is operative for modulating the green laser beam with a concomitant delay, this invention further proposes that the controller be operative for causing the selected pixels from the modulated diffracted green beam to be illuminated simultaneously with selected pixels from the red and the blue laser beams.

It is advantageous if a support is provided for supporting the laser assembly, the optical assembly, the AOM and the scanner. The support, lasers, AOM, scaimier, controller and optical assembly preferably occupy a volume of about seventy cubic centimeters, thereby constituting a compact module, which is interchangeably mountable in housings of different form factors, including, but not limited to, a pen-shaped, gun-shaped or flashlight-shaped instrument, a personal digital assistant, a pendant, a watch, a computer, and, in short, any shape due to its compact and miniature size. The projected image can be used for advertising or signage purposes, or for a television or computer monitor screen, and, in short, for any purpose desiring something to be displayed.

In addition, the output power of each laser must be monitored for safety. Although the image brightness is enhanced when the output power of each laser is increased, government regulatory safety standards dictate the maximum power output of each laser for human safety. Hence, this invention further proposes providing a detector for detecting an output power of the modulated non-diffracted green beam, and a safety circuit for deenergizing at least one of the green laser and the AOM when the output power of the modulated non-diffracted green beam is not within a preestablished range of output powers. The output power of the modulated non-diffracted green beam can also be used to compensate for the non-linear diffraction response of the AOM.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a hand-held instrument projecting an image at a working distance therefrom;

FIG. 2 is an enlarged, overhead, perspective view of an image projection arrangement in accordance with this invention for installation in the instrument of FIG. 1;

FIG. 3 is a top plan view of the arrangement of FIG. 2;

FIG. 4 is a perspective front view of an inertial drive for use in the arrangement of FIG. 2;

FIG. 5 is a perspective rear view of the inertial drive of FIG. 4;

FIG. 6 is a perspective view of a practical implementation of the arrangement of FIG. 2;

FIG. 7 is an electrical schematic block diagram depicting operation of the arrangement of FIG. 2;

FIG. 8 is a schematic view of a green laser and a focusing lens used in the arrangement of FIG. 2;

FIG. 9 is a schematic view of the green laser and focusing lens of FIG. 8 used with an AOM in the arrangement of FIG. 2;

FIG. 10 is an electrical schematic block diagram depicting a safety circuit for the green laser and the AOM of FIG. 9;

FIG. 11 is electrical schematic block diagram depicting the synchronization among the red, blue and green beams used in the arrangement of FIG. 2;

FIG. 12 is an enlarged view of a detail of FIG. 1; and

FIG. 13 is an explanatory set of timing diagrams for explaining the operation of the circuits of FIGS. 11-12.

### DETAILED DESCRIPTION OF THE PREFERRED EMBODIMENTS

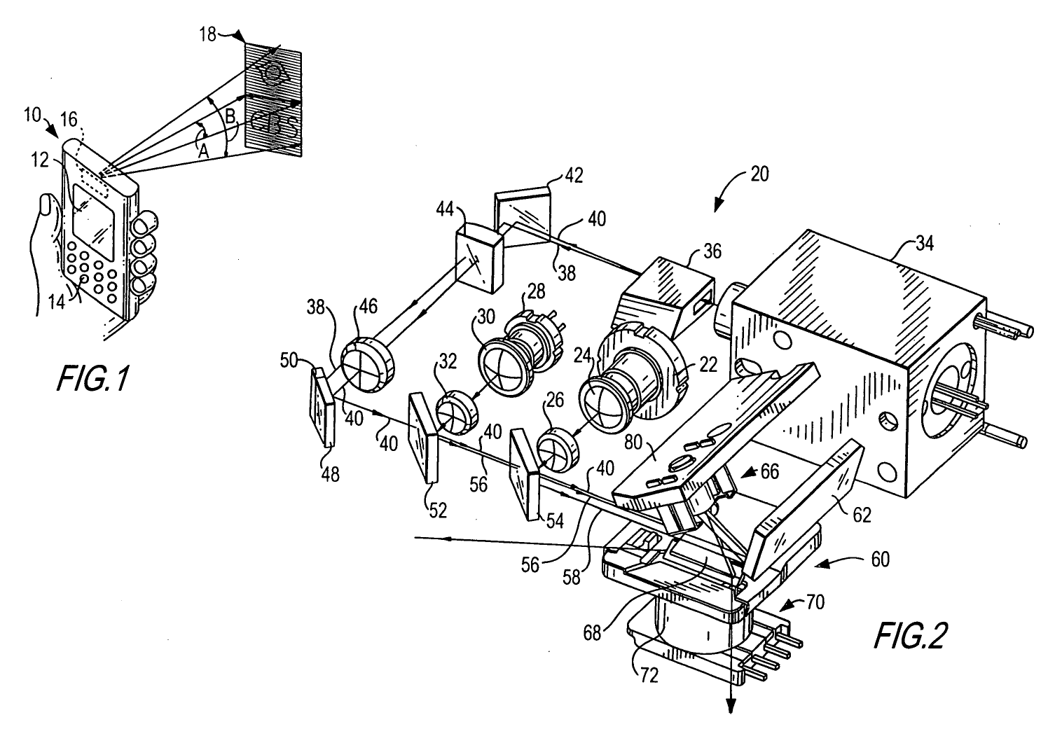

Reference numeral 10 in FIG. 1 generally identifies a hand-held instrument, for example, a personal digital assistant, in which a lightweight, compact, image projection arrangement 20, as shown in FIG. 2, is mounted and operative for projecting a two-dimensional color image on a projection surface at a variable distance from the instrument. By way of example, an image 18 is situated within a working range of distances relative to the instrument 10.

As shown in FIG. 1, the image 18 extends over an optical horizontal scan angle A extending along the horizontal direction, and over an optical vertical scan angle B extending along the vertical direction, of the image. As described below, the image is comprised of illuminated and non-illuminated pixels on a raster pattern of scan lines swept by a scanner in the arrangement 20.

The parallelepiped shape of the instrument 10 represents just one form factor of a housing in which the arrangement 20 may be implemented. The instrument can be shaped with many different form factors, such as a pen, a cellular telephone, a clamshell or a wristwatch.

In the preferred embodiment, the arrangement 20 measures about seventy cubic centimeters in volume. This compact, miniature size allows the arrangement 20 to be mounted in housings of many diverse shapes, large or small, portable or stationary, including some having an on-board display 12, a keypad 14, and a window 16 through which the image is projected.

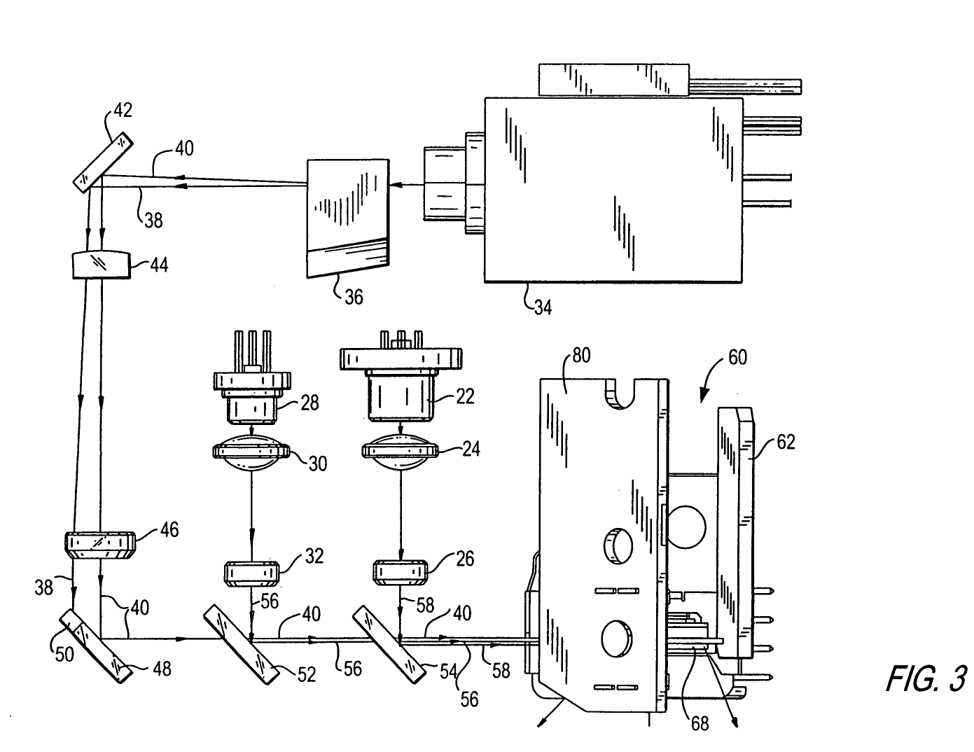

Referring to FIGS. 2 and 3, the arrangement 20 includes a solid-state, preferably a semiconductor laser 22 which, when energized, emits a bright red laser beam at about 635-655 nanometers. Lens 24 is a bi-aspheric convex lens having a positive focal length and is operative for collecting virtually all the energy in the red beam and for producing a diffraction-limited beam. Lens 26 is a concave lens having a negative focal length. Lenses 24, 26 are held by non-illustrated respective lens holders apart on a support (not illustrated in FIG. 2 for clarity) inside the instrument 10. The lenses 24, 26 shape the red beam profile over the working distance.

Another solid-state, semiconductor laser 28 is mounted on the support and, when energized, emits a diffraction-limited blue laser beam at about 440 nanometers. Another bi-aspheric convex lens 30 and a concave lens 32 are employed to shape the blue beam profile in a manner analogous to lenses 24, 26.

A green laser beam having a wavelength on the order of 532 nanometers is generated not by a semiconductor laser, but instead by a green module 34 having an infrared diode-pumped, Nd-doped, YAG crystal solid-state (DPSS) laser whose output beam at 1064 nanometers. A non-linear frequency doubling crystal is included in the infrared laser cavity between two laser mirrors. Since the infrared laser power inside the cavity is much larger than the power coupled outside the cavity, the frequency doubler is more efficient in generating the double frequency green light inside the cavity. The output mirror of the laser is reflective to the 1064 nm infrared radiation, and transmissive to the doubled 532 nm green laser beam. Since the correct operation of the solid-state laser and frequency doubler requires precise temperature control, a semiconductor device relying on the Peltier effect is used to control the temperature of the green laser module. The thermo-electric cooler can either heat or cool the device depending on the polarity of the applied current. A thermistor is part of the green laser module in order to monitor its temperature. The readout from the thermistor is fed to a controller, which adjusts the control current to the thermo-electric cooler accordingly.

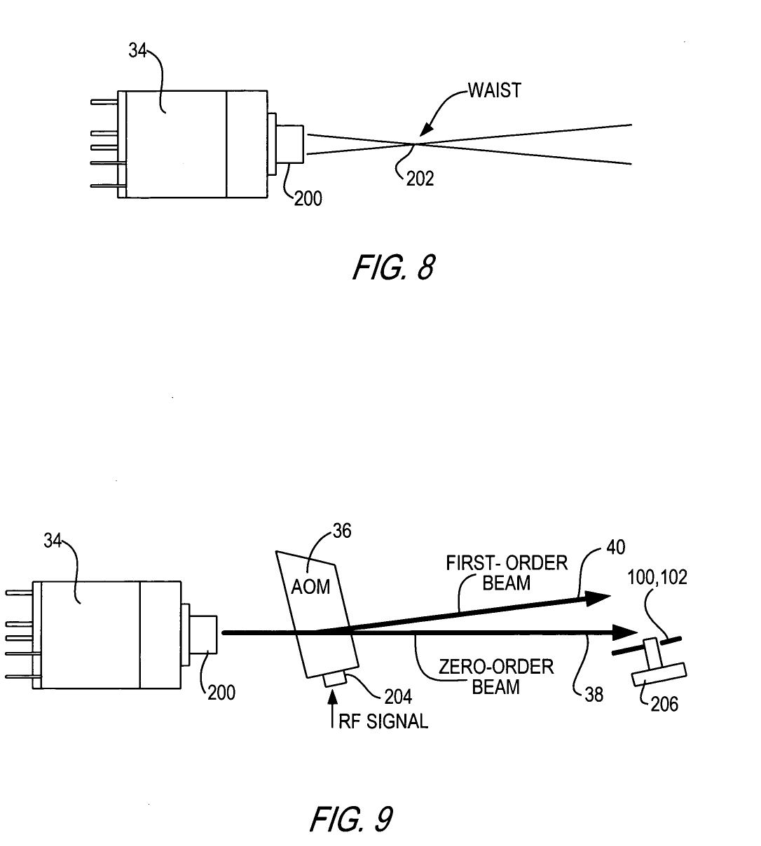

As explained above, the lasers are modulated in operation at frequencies on the order of 100 MHz. The red and blue semiconductor lasers 22, 28 can be pulsed directly via the applied drive currents at such high modulation frequencies, but the currently available green solid-state (DPSS) lasers cannot. As a result, the green laser beam exiting the green module 34 is modulated with an external acousto-optical modulator (AOM) 36. As shown in FIG. 8, the green beam is focused by a focusing lens 200 to a waist 202 having a size on the order of 100 micrometers or less and is positioned generally in the center of the AOM (see FIG. 9).

A radio frequency (RF) signal of variable amplitude and derived from the incoming video signal is applied to a piezoelectric transducer 204 operative to propagate an acoustic traveling wave inside a crystal in the AOM. The AOM is optimally aligned with the incident green beam at a positive Bragg angle (22 milliradians) and generates a modulated non-diffracted green beam 38 as a zero-order beam and a modulated diffracted green beam 40 as a positive first-order beam. The AOM could also be aligned at a negative Bragg angle, in which case, the modulated diffracted green beam is a negative first-order beam As shown in FIG. 9, the non-diffracted zero-order green beam is collinear with the incident green beam and, hence, would be easier to align with the optical components described below. However, this invention instead employs the modulated diffracted green beam because the modulated diffracted green beam can be completely turned off, thereby enhancing the contrast and the extinction ratio between the illuminated and the non-illuminated pixels. The modulated non-diffracted green beam cannot be completely turned off.

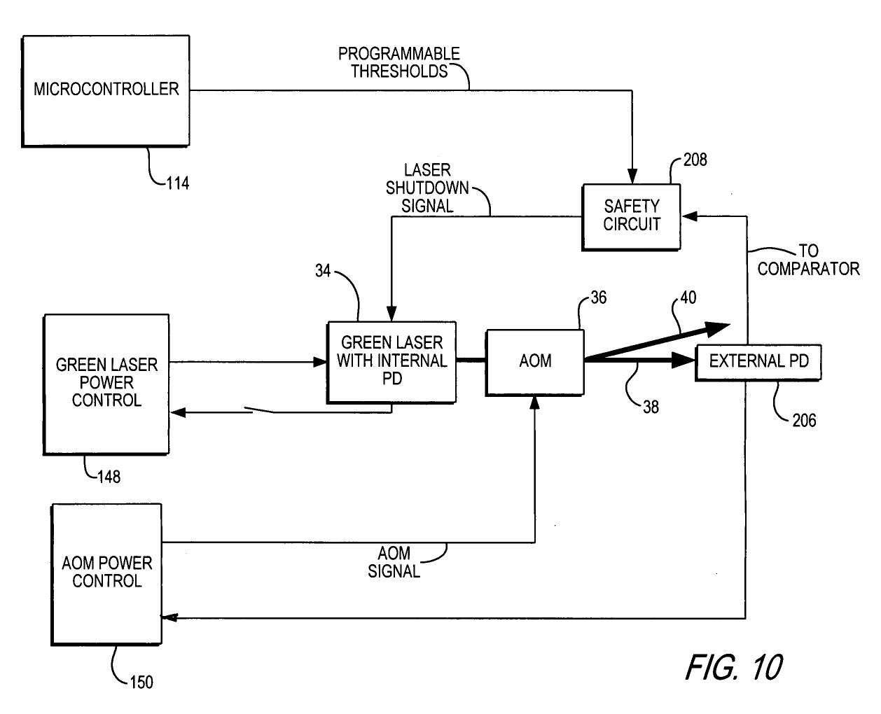

The beams 38, 40 diverge from each other at twice the Bragg angle and are routed along a long, folded path having a folding mirror 42. Alternatively, the AOM can be used internally of the green laser module to pulse the green laser beam. Other possible ways to modulate the green laser beam include electro-absorption modulation, or a Mach-Zender interferometer. The beams 38, 40 are routed through positive and negative lenses 44, 46. As shown in FIG. 2, only the diffracted green beam 40 is allowed to impinge upon, and reflect from, the folding mirror 48. The non-diffracted beam 38 is absorbed by an absorber 50, preferably mounted on the mirror 48. The non-diffracted beam 38 need not be useless, but can usefully be employed as part of a safety circuit as described below in connection with FIGS. 9-10.

The arrangement includes a pair of dichroic filters 52, 54 arranged to make the diffracted green beam, the blue beam and the red beam as collinear as possible before reaching a scanning assembly 60. Filter 52 allows the diffracted green beam 40 to pass therethrough, but the blue beam 56 from the blue laser 28 is reflected by the interference effect. Filter 54 allows the diffracted green beam 40 and the blue beam 56 to pass therethrough, but the red beam 58 from the red laser 22 is reflected by the interference effect.

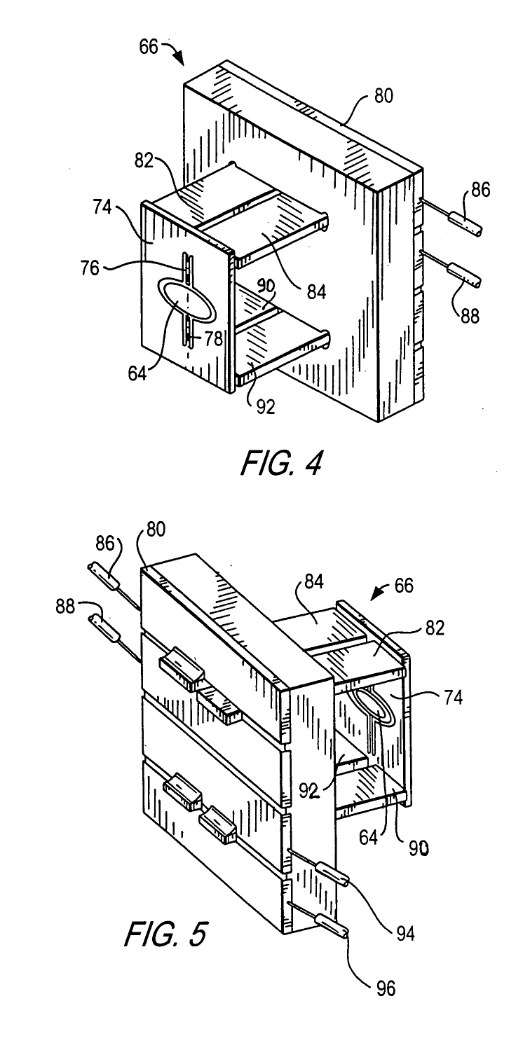

The nearly collinear beams 40, 56, 58 are directed to, and reflected off, a stationary fold mirror 62. The scanning assembly 60 includes a first scan mirror 64 oscillatable by an inertial drive 66 (shown in isolation in FIGS. 4-5) at a first scan rate to sweep the laser beams reflected off the fold mirror 62 over the first horizontal scan angle A, and a second scan mirror 68 oscillatable by an electromagnetic drive 70 at a second scan rate to sweep the laser beams reflected off the first scan mirror 64 over the second vertical scan angle B. In a variant construction, the scan mirrors 64, 68 can be replaced by a single two-axis mirror.

The inertial drive 66 is a high-speed, low electrical power-consuming component. Details of the inertial drive can be found in U.S. patent application Ser. No. 10/387,878, filed Mar. 13, 2003, assigned to the same assignee as the instant application, and incorporated herein by reference thereto. The use of the inertial drive reduces power consumption of the scanning assembly 60 to less than one watt and, in the case of projecting a color image, as described below, to less than ten watts.

The drive 66 includes a movable frame 74 for supporting the scan mirror 64 by means of a hinge that includes a pair of collinear hinge portions 76, 78 extending along a hinge axis and connected between opposite regions of the scan mirror 64 and opposite regions of the frame. The frame 74 need not surround the scan mirror 64, as shown.

The frame, hinge portions and scan mirror are fabricated of an integral, generally planar, silicon substrate, which is approximately 150 microns thick. The silicon is etched to form omega-shaped slots having upper parallel slot sections, lower parallel slot sections, and U-shaped central slot sections. The scan mirror 64 preferably has an oval shape and is free to move in the slot sections. In the preferred embodiment, the dimensions along the axes of the oval-shaped scan mirror measure 749 microns×1600 microns. Each hinge portion measures 27 microns in width and 1130 microns in length. The frame has a rectangular shape measuring 3100 microns in width and 4600 microns in length.

The inertial drive is mounted on a generally planar, printed circuit board 80 and is operative for directly moving the frame and, by inertia, for indirectly oscillating the scan mirror 64 about the hinge axis. One embodiment of the inertial drive includes a pair of piezoelectric transducers 82, 84 extending perpendicularly of the board 80 and into contact with spaced apart portions of the frame 74 at either side of hinge portion 76. An adhesive may be used to insure a permanent contact between one end of each transducer and each frame portion. The opposite end of each transducer projects out of the rear of the board 80 and is electrically connected by wires 86, 88 to a periodic alternating voltage source (not shown).

In use, the periodic signal applies a periodic drive voltage to each transducer and causes the respective transducer to alternatingly extend and contract in length. When transducer 82 extends, transducer 84 contracts, and vice versa, thereby simultaneously pushing and pulling the spaced apart frame portions and causing the frame to twist about the hinge axis. The drive voltage has a frequency corresponding to the resonant frequency of the scan mirror. The scan mirror is moved from its initial rest position until it also oscillates about the hinge axis at the resonant frequency. In a preferred embodiment, the frame and the scan mirror are about 150 microns thick, and the scan mirror has a high Q factor. A movement on the order of 1 micron by each transducer can cause oscillation of the scan mirror at scan angles in excess of 15 degrees.

Another pair of piezoelectric transducers 90, 92 extends perpendicularly of the board 80 and into permanent contact with spaced apart portions of the frame 74 at either side of hinge portion 78. Transducers 90, 92 serve as feedback devices to monitor the oscillating movement of the frame and to generate and conduct electrical feedback signals along wires 94, 96 to a feedback control circuit (not shown).

Although light can reflect off an outer surface of the scan mirror, it is desirable to coat the surface of the mirror 64 with a specular coating made of gold, silver, aluminum, or a specially designed highly reflective dielectric coating.

The electromagnetic drive 70 includes a permanent magnet jointly mounted on and behind the second scan mirror 68, and an electromagnetic coil 72 operative for generating a periodic magnetic field in response to receiving a periodic drive signal. The coil 72 is adjacent the magnet so that the periodic field magnetically interacts with the permanent field of the magnet and causes the magnet and, in turn, the second scan mirror 68 to oscillate.

The inertial drive 66 oscillates the scan mirror 64 at a high speed at a scan rate preferably greater than 5 kHz and, more particularly, on the order of 18 kHz or more. This high scan rate is at an inaudible frequency, thereby minimizing noise and vibration. The electromagnetic drive 70 oscillates the scan mirror 68 at a slower scan rate on the order of 40 Hz which is fast enough to allow the image to persist on a human eye retina without excessive flicker.

The faster mirror 64 sweeps a generally horizontal scan line, and the slower mirror 68 sweeps the generally horizontal scan line vertically, thereby creating a raster pattern which is a grid or sequence of roughly parallel scan lines from which the image is constructed. Each scan line has a number of pixels. The image resolution is preferably XGA quality of 1024×768 pixels. Over a limited working range, a high-definition television standard, denoted 720 p, 1270×720 pixels, can be obtained. In some applications, a one-half VGA quality of 320×480 pixels, or one-fourth VGA quality of 320×240 pixels, is sufficient. At minimum, a resolution of 160×160 pixels is desired.

The roles of the mirrors 64, 68 could be reversed so that mirror 68 is the faster, and mirror 64 is the slower. Mirror 64 can also be designed to sweep the vertical scan line, in which event, mirror 68 would sweep the horizontal scan line. Also, the inertial drive can be used to drive the mirror 68. Indeed, either mirror can be driven by an electromechanical, electrical, mechanical, electrostatic, magnetic, or electromagnetic drive.

The slow-mirror is operated in a constant velocity sweep-mode during which time the image is displayed. During the mirror's return, the mirror is swept back into the initial position at its natural frequency, which is significantly higher. During the mirror's return trip, the lasers can be powered down in order to reduce the power consumption of the device.

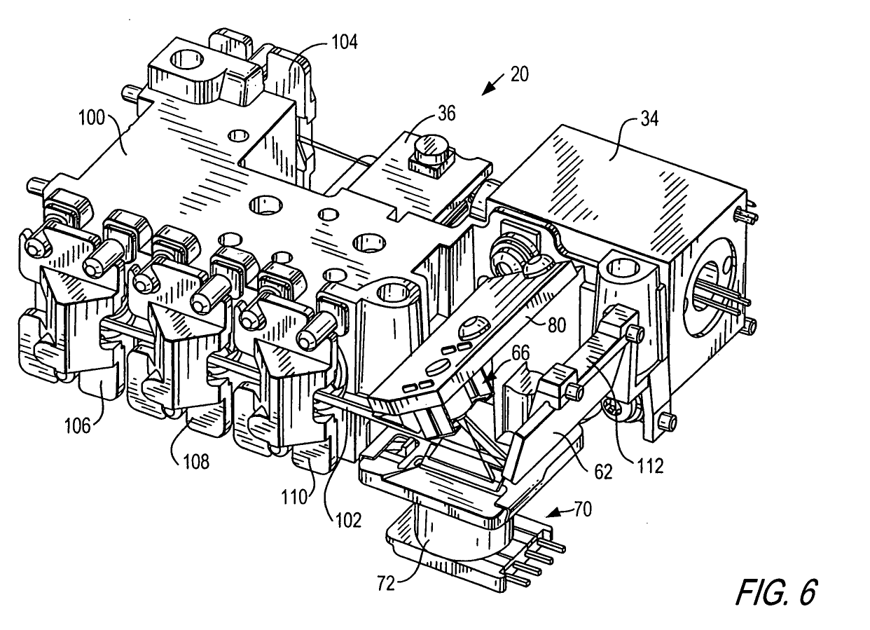

FIG. 6 is a practical implementation of the arrangement 20 in the same perspective as that of FIG. 2. The aforementioned components are mounted on a support, which includes a top cover 100 and a support plate 102. Holders 104, 106, 108, 110, 112 respectively hold folding mirrors 42, 48, filters 52, 54 and fold mirror 62 in mutual alignment. Each holder has a plurality of positioning slots for receiving positioning posts stationarily mounted on the support. Thus, the mirrors and filters are correctly positioned. As shown, there are three posts, thereby permitting two angular adjustments and one lateral adjustment. Each holder can be glued in its final position.

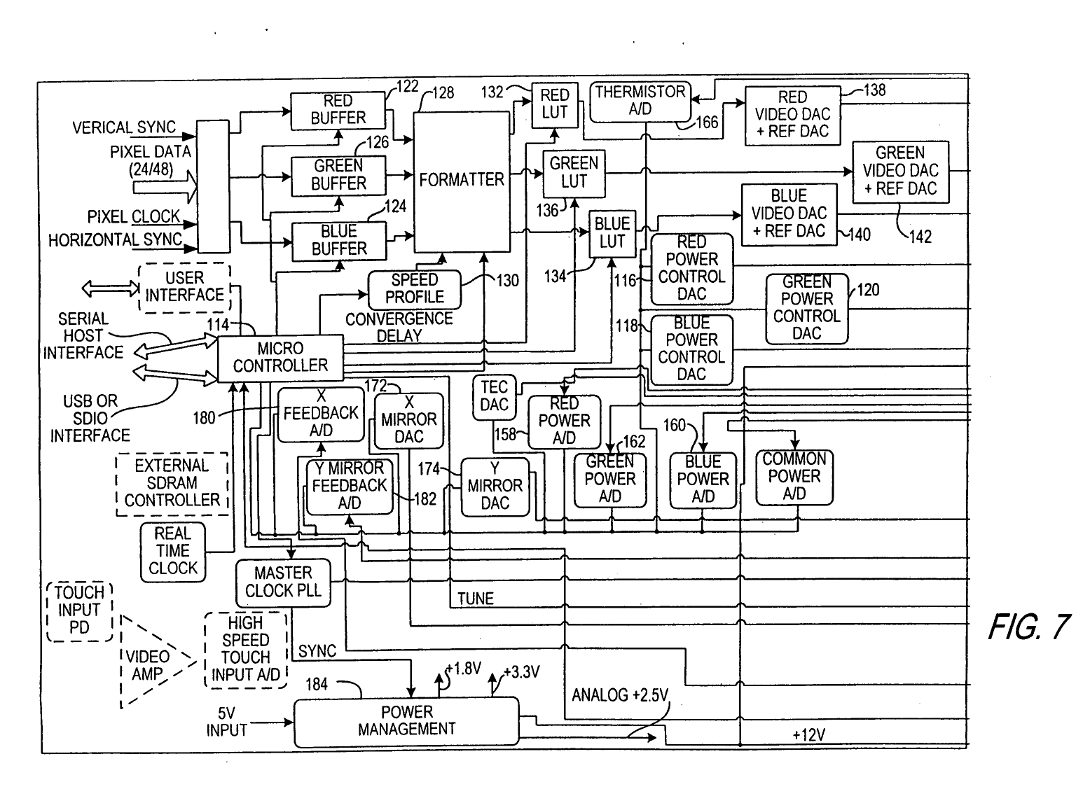

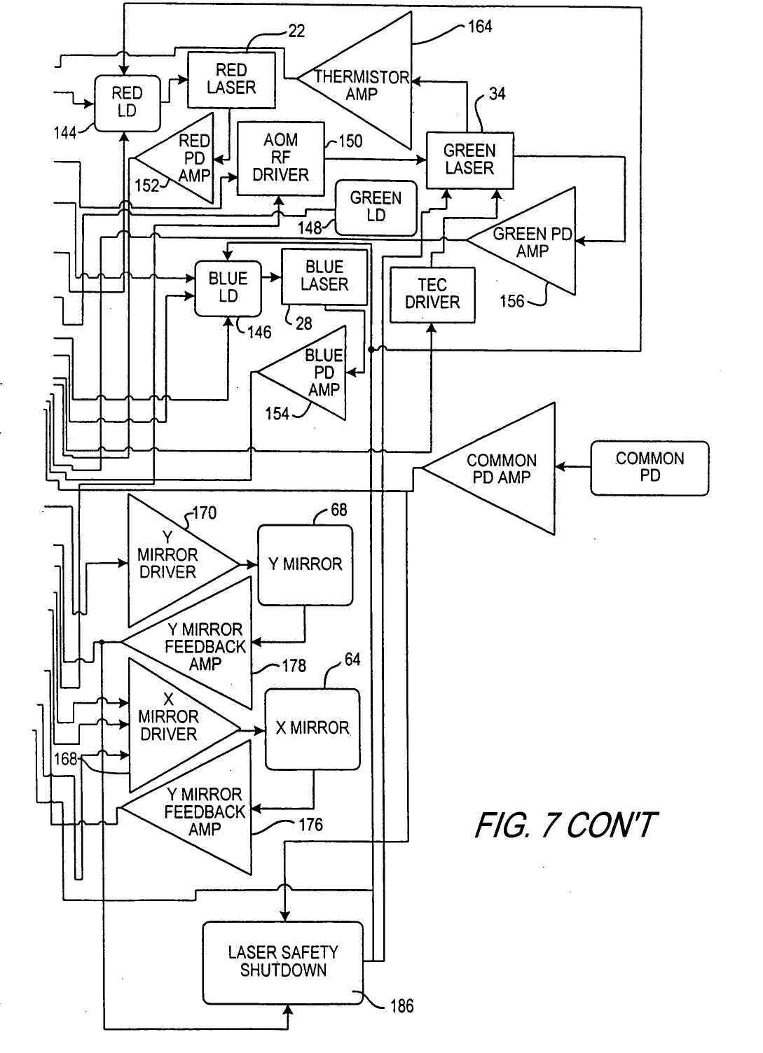

The image is constructed by selective illumination of the pixels in one or more of the scan lines. As described below in greater detail with reference to FIG. 7, a controller 114 causes selected pixels in the raster pattern to be illuminated, and rendered visible, by the three laser beams. For example, red, blue and green power controllers 116, 118, 120 respectively conduct electrical currents to the red, blue and green lasers 22, 28, 34 to energize the latter to emit respective light beams at each selected pixel, and do not conduct electrical currents to the red, blue and green lasers to deenergize the latter to non-illuminate the other non-selected pixels. The resulting pattern of illuminated and non-illuminated pixels comprises the image, which can be any display of human- or machine-readable information or graphic.

Referring to FIG. 1, the raster pattern is shown in an enlarged view. Starting at an end point, the laser beams are swept by the inertial drive along the generally horizontal direction at the horizontal scan rate to an opposite end point to form a scan line. Thereupon, the laser beams are swept by the electromagnetic drive 70 along the vertical direction at the vertical scan rate to another end point to form a second scan line. The formation of successive scan lines proceeds in the same manner.

The image is created in the raster pattern by energizing or pulsing the lasers on and off at selected times under control of the microprocessor 114 or control circuit by operation of the power controllers 116, 118, 120. The lasers produce visible light and are turned on only when a pixel in the desired image is desired to be seen. The color of each pixel is determined by one or more of the colors of the beams. Any color in the visible light spectrum can be formed by the selective superimposition of one or more of the red, blue, and green lasers. The raster pattern is a grid made of multiple pixels on each line, and of multiple lines. The image is a bit-map of selected pixels. Every letter or number, any graphical design or logo, and even machine-readable bar code symbols, can be formed as a bit-mapped image.

As shown in FIG. 7, an incoming video signal having vertical and horizontal synchronization data, as well as pixel and clock data, is sent to red, blue and green buffers 122, 124, 126 under control of the microprocessor 114. The storage of one full VGA frame requires many kilobytes, and it would be desirable to have enough memory in the buffers for two full frames to enable one frame to be written, while another frame is being processed and projected. The buffered data is sent to a formatter 128 under control of a speed profiler 130 and to red, blue and green look up tables (LUTs) 132, 134, 136 to correct inherent internal distortions caused by scamming, as well as geometrical distortions caused by the angle of the display of the projected image. The resulting red, blue and green digital signals are converted to red, blue and green analog signals by digital to analog converters (DACs) 138, 140, 142. The red and blue analog signals are fed to red and blue laser drivers (LDs) 144, 146 which are also connected to the red and blue power controllers 116, 118. The green analog signal is fed to an acousto-optical module (AOM) radio frequency (RF) driver 150 and, in turn, to the green laser 34 which is also connected to a green LD 148 and to the green power controller 120.

Feedback controls are also shown in FIG. 7, including red, blue and green photodiode amplifiers 152, 154, 156 connected to red, blue and green analog-to-digital (A/D) converters 158, 160, 162 and, in turn, to the microprocessor 114. Heat is monitored by a thermistor amplifier 164 connected to an A/D converter 166 and, in turn, to the microprocessor.

The scan mirrors 64, 68 are driven by drivers 168, 170 which are fed analog drive signals from DACs 172, 174 which are, in turn, connected to the microprocessor. Feedback amplifiers 176, 178 detect the position of the scan mirrors 64, 68, and are connected to feedback A/Ds 180, 182 and, in turn, to the microprocessor.

A power management circuit 184 is operative to minimize power while allowing fast on-times, preferably by keeping the green laser on all the time, and by keeping the current of the red and blue lasers just below the lasing threshold.

A laser safety shut down circuit 186 is operative to shut the lasers off if either of the scan mirrors 64, 68 is detected as being outside of rated values.

Turning now to FIGS. 9-10, the green module 34 has an internal photodiode normally operative for monitoring the green laser output power. The internal photodiode is part of a feedback circuit connected to the green laser drive 148 for maintaining the green laser output power constant during operation. For additional safety, it is desired to know the magnitude of the output power of the green laser. An external photodiode 206 is provided for detecting an output power of the modulated non-diffracted beam 38. The detected output power can be used to deenergize the AOM 36 via the AOM drive 150 which generates an AOM control signal. The detected output power can also be used to control the non-linear diffraction response of the AOM, also via the AOM control signal generated by the AOM drive 150. In addition, the detected output power can be sent to a comparator and a safety circuit 208 which are operative for generating a laser shutdown signal for deenergizing the green laser module 34 when the output power of the modulated non-diffracted beam 38 is not within a preestablished range of output powers set as programmed threshold values by the microcontroller 114.

The external photodiode 206 is preferably mounted in a mounting hole on the support 100, 102 (see FIG. 9) and collects the modulated non-diffracted beam 38 scattered by an internal wall of the support. A tri-valent chromate coating can be applied on the support 100, 102. This coating is stable over time so that the amount of light in the modulated non-diffracted beam collected by the external photodiode 206 does not change over time. A light guide may be used to guide the light to the external photodiode 206. The output power of the modulated non-diffracted beam 38 is proportional to the total output power of the incident green beam.

Since the acoustic wave within the AOM travels at a finite speed, there is a small, but non-negligible, time delay between the moment the RF signal is applied to the transducer 204 and the moment that the acoustic wave interacts with the incident green beam to generate the beams 38, 40. This results in a time difference between the AOM-modulated diffracted green beam 40 and the directly modulated red and blue beams 58, 56. This invention further proposes compensating for this time difference so that the three beams can simultaneously arrive at the projection surface.

The time delay is a fixed value and can be determined from the acoustic speed which is based on the material properties of the crystal, as well as from the geometry of the AOM. For example, if the acoustic speed is 4000 meters per second, and the distance from the face of the AOM to the incident green beam is 1 mm, then a 250 nsec time delay must be taken into account.

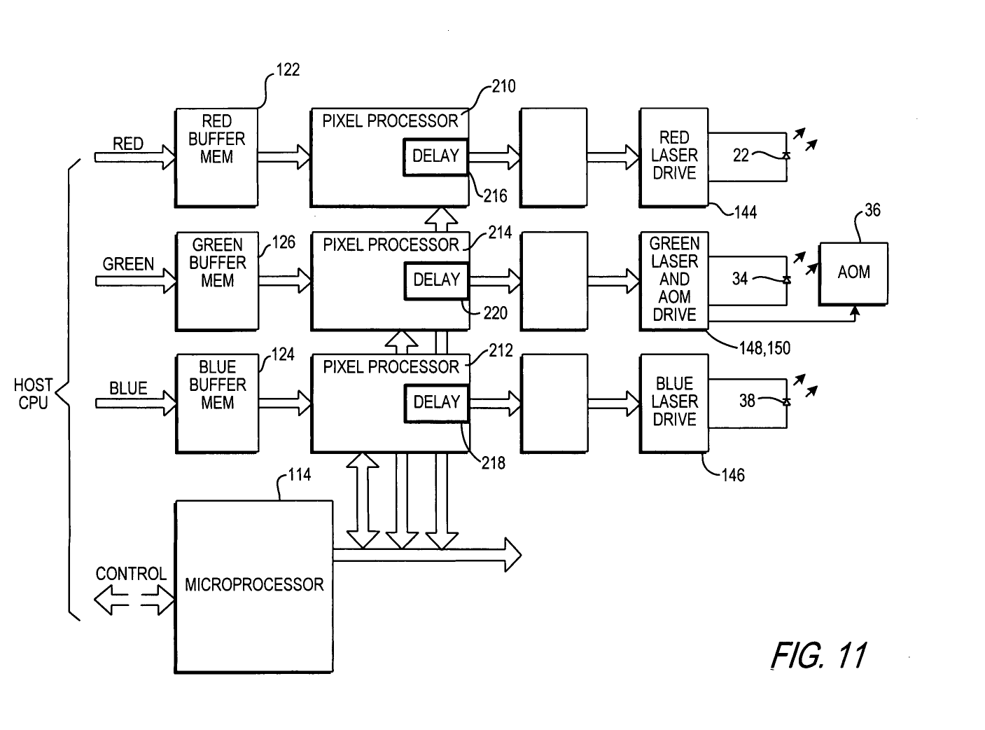

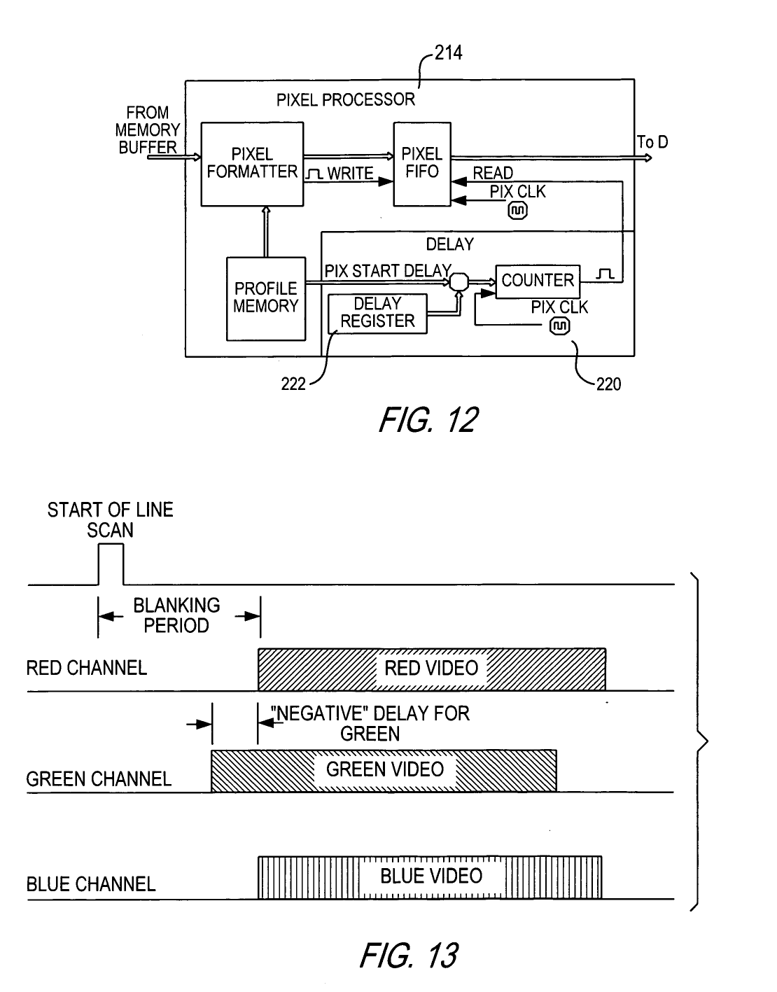

In FIG. 11, the red, blue and diffracted green beams have respective red, blue and green pixel processors 210, 212, 214, each having respective red, blue and green delay elements 216, 218, 220. FIG. 12 depicts green pixel processor 214 and its delay element 220 in more detail. Essentially, the green pixel processor 214 can be speeded up and/or the red and blue pixel processors 210, 212 can be slowed down.

In the preferred embodiment, there is a blanking period between the start of a scan line and the actual start of the active red, blue and green pixels to be illuminated or not illuminated. The time delay adjustment can be accomplished by shortening the blanking time of the green pixels. This is equivalent to speeding up the green pixels. A delay register 222 is employed to add a negative delay for the green channel data, as depicted in FIG. 13.

It will be understood that each of the elements described above, or two or more together, also may find a useful application in other types of constructions differing from the types described above.

While the invention has been illustrated and described as embodied in an arrangement for and a method of projecting an image with modulated lasers, it is not intended to be limited to the details shown, since various modifications and structural changes may be made without departing in any way from the spirit of the present invention.

For example, the invention is not intended to be limited to green lasers and equally well applies to blue or red DPSS lasers where high output powers are required for a particular application.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

We claim:

1. An image projection arrangement for projecting an image, comprising:
a) a laser assembly for generating a laser beam;
b) an acousto-optical modulator (AOM) for modulating the laser beam, and for generating a modulated non-diffracted beam and a modulated diffracted beam;
c) a scanner for sweeping the modulated diffracted beam as a pattern of scan lines at a distance from the laser assembly, each scan line having a number of pixels; and
d) a controller operatively connected to the laser assembly, the AOM, and the scanner, for causing selected pixels along the scan lines to be illuminated, and rendered visible, by the modulated diffracted beam to produce the image.

2. The image projection arrangement of claim 1, wherein the laser assembly includes a plurality of lasers for respectively generating a plurality of laser beams of different wavelengths, and an optical assembly for focusing and nearly collinearly arranging the laser beams to form the laser beam as a composite beam which is directed to the scanner.

3. The image projection arrangement of claim 2, wherein the lasers include red and blue, semiconductor lasers for respectively generating red and blue laser beams.

4. The image projection arrangement of claim 3, wherein the lasers include a diode-pumped YAG laser and an optical frequency doubler for producing a green laser beam.

5. The image projection arrangement of claim 1, wherein the laser assembly generates the laser beam as a green laser beam, and wherein the AOM is operative for modulating the green laser beam.

6. The image projection arrangement of claim 5, and a focusing lens operative for focusing the green laser beam inside the AOM.

7. The image projection arrangement of claim 1, and a detector for detecting an output power of the modulated non-diffracted beam, and a safety circuit for deenergizing at least one of the laser assembly and the AOM when the output power of the modulated non-diffracted beam is not within a preestablished range of output powers.

8. The image projection arrangement of claim 1, and a detector for detecting an output power of the modulated non-diffracted beam, and a circuit for controlling a non-linear diffraction response of the AOM.

9. The image projection arrangement of claim 1, and a block for absorbing the modulated diffracted beam.

10. The image projection arrangement of claim 1, wherein the laser assembly includes a plurality of lasers for respectively generating a plurality of laser beams of different wavelengths, and wherein the AOM is operative for modulating one of the laser beams with a concomitant delay, and wherein the controller is operative for causing the selected pixels from the modulated diffracted beam to be illuminated simultaneously with selected pixels from the others of the laser beams.

11. The image projection arrangement of claim 1, wherein the scanner includes a first oscillatable scan mirror operative for sweeping the modulated diffracted beam along a first direction at a first scan rate and over a first scan angle, and wherein the scanner includes a second oscillatable scan mirror for sweeping the modulated diffracted beam along a second direction substantially perpendicular to the first direction, and at a second scan rate different from the first scan rate, and at a second scan angle different from the first scan angle.

12. The image projection arrangement of claim 1, wherein the controller includes means for energizing the laser assembly to illuminate the selected pixels, and for deenergizing the laser assembly to non-illuminate pixels other than the selected pixels.

13. An image projection arrangement for projecting a two-dimensional, color image on a projection surface, comprising:
a) a support;
b) a laser assembly including red, blue and green lasers on the support, for respectively emitting a plurality of red, blue and green laser beams;
c) an acousto-optical modulator (AOM) for modulating the green laser beam, and for generating a modulated non-diffracted green beam and a modulated diffracted green beam;
d) an optical assembly on the support, for optically focusing and collinearly arranging the red beam, the blue beam, and the modulated diffracted green beam to form a composite beam;
e) a scanner on the support, for sweeping the composite beam in a pattern of scan lines at a distance from the support on the projection surface, each scan line having a number of pixels; and
f) a controller operatively connected to the laser assembly and the scanner, for causing selected pixels to be illuminated, and rendered visible, by the composite beam to produce the image, the controller being operative for selecting at least some of the laser beams to illuminate the selected pixels to produce the image with color.

14. The image projection arrangement of claim 13, and a focusing lens operative for focusing the green laser beam inside the AOM.

15. The image projection arrangement of claim 13, and a detector for detecting an output power of the modulated non-diffracted green beam, and a safety circuit for deenergizing at least one of the green laser and the AOM when the output power of the modulated non-diffracted green beam is not within a preestablished range of output powers.

16. The image projection arrangement of claim 13, and a detector for detecting an output power of the modulated non-diffracted green beam, and a circuit for controlling a non-linear diffraction response of the AOM.

17. The image projection arrangement of claim 13, and a detector for detecting an output power of the modulated non-diffracted green beam, and a coating on the support for controlling the output power of the modulated non-diffracted green beam.

18. The image projection arrangement of claim 13, and wherein the AOM is operative for modulating the green laser beam with a concomitant delay, and wherein the controller is operative for causing the selected pixels from the modulated diffracted green beam to be illuminated simultaneously with selected pixels from the red and the blue laser beams.

19. An image projection arrangement for projecting an image, comprising:
a) laser means for generating a laser beam;
b) acousto-optical modulator (AOM) means for modulating the laser beam, and for generating a modulated non-diffracted beam and a modulated diffracted beam;
c) scanner means for sweeping the modulated diffracted beam as a pattern of scan lines at a distance from the laser means, each scan line having a number of pixels; and
d) controller means operatively connected to the laser means, the AOM means, and the scanner means, for causing selected pixels along the scan lines to be illuminated, and rendered visible, by the modulated diffracted beam to produce the image.

20. An image projection module for projecting an image on a projection surface, comprising:
a) a support;
b) a laser assembly on the support, for generating a laser beam;
c) an acousto-optical modulator (AOM) on the support, for modulating the laser beam, and for generating a modulated non-diffracted beam and a modulated diffracted beam;
d) a scanner on the support, for sweeping the modulated diffracted beam as a pattern of scan lines at a distance from the support on the projection surface, each scan line having a number of pixels; and
e) a controller operatively connected to the laser assembly, the AOM, and the scanner, for causing selected pixels along the scan lines to be illuminated, and rendered visible, by the modulated diffracted beam to produce the image.

21. A method of projecting an image, comprising the steps of:
a) generating a laser beam;
b) modulating the laser beam, and generating a modulated non-diffracted beam and a modulated diffracted beam;
c) sweeping the modulated diffracted beam as a pattern of scan lines, each scan line having a number of pixels; and
d) causing selected pixels along the scan lines to be illuminated, and rendered visible, by the modulated diffracted beam to produce the image.

22. The image projection method of claim 21, wherein the venerating step is performed by generating a green laser beam, and wherein the modulating step is performed by modulating the green laser beam.

23. The image projection method of claim 21, and the step of detecting an output power of the modulated non-diffracted beam, and the step of discontinuing at least one of the generating and the modulating steps when the output power of the modulated non-diffracted beam is not within a preestablished range of output powers.

24. The image projection method of claim 21, wherein the generating step is performed by generating a plurality of laser beams of different wavelengths, and wherein the modulating step is performed by modulating one of the laser beams with a concomitant delay, and wherein the causing step is performed by causing the selected pixels from the modulated diffracted beam to be illuminated simultaneously with selected pixels from the others of the laser beams.
